(19) United States
(12) Patent Application Publication
(10) Pub. No.: US 2004/0066849 A1
(43) Pub. Date: Apr. 8, 2004

(54) Method and system for significance-based embedded motion-compensation wavelet video coding and transmission

(75) Inventor: Mihaela Van Der Schaar, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/264,894

(22) Filed: Oct. 4, 2002

(51) Int. Cl. H04N 7/12

(52) U.S. Cl. 375/240.19; 375/240.16

(57) ABSTRACT

Methods and devices for applying motion compensation to wavelet encoded video images and for transmitting the motion compensated wavelet encoded video images. One aspect of the invention involves an encoding device and method operable for organizing wavelet encoded images into a plurality of bit-planes, inverse wavelet transforming selected ones of the bit-planes wherein an image corresponding to the inverse wavelet transformed bit-planes is representative of said video image and estimating motion between the video image and the inverse wavelet transformed images. Another aspect involves, a transmitting device and method for identifying a type of frame and initiating a first significance based transmission process when a first type of frame is determined and initiating a second significance based transmission process when a second type of frame is determined.

### FIELD OF THE INVENTION

The present invention is directed toward streaming video technology and more specifically toward methods for formulating motion compensation of wavelet encoded images.

### BACKGROUND OF THE INVENTION

Digital encoding of images using wavelet encoding is well known in the art and is described, for example, in “Embedded Image Coding Using Zerotrees of Wavelet Coefficients,” J. Shapiro, IEEE Transactions on Signal Processing, Vol. 41, No. 12, December 1993. Wavelet encoding contains the following features; a discrete wavelet transform which provides a compact multiresolution representation of the image; Zerotree coding which provides a compact multiresolution of significance maps, which are binary maps that indicates the positions of the significant coefficients; successive approximation which provides a compact multiprecision representation of the significant coefficients; a prioritization protocol whereby the ordering of importance is determined, in order, by the precision, magnitude, scale and spatial location of the wavelet coefficient; adapative multilevel arithmetic coding; and sequential operation to stop bit rate transmission when a target bit rate or a target distortion is met.

However, while wavelet encoding demonstrates significant capability to provide images of varying resolution, its ability to provide motion compensation is labored. In one proposed method, referred to as 2D wavelet coding, a separate motion compensation (MC) predication is necessary for each resolution level. In this application, MC must be accurate enough to prevent aliasing. In another proposed method, referred to as 3D wavelet coding, there exists a significantly large coding penalty loss.

Hence, there is a need for a method that allows for the transmission of wavelet encoded images using motion compensation without a significant transmission or coding penalty and that utilizes the benefits of wavelet encoding.

### SUMMARY OF THE INVENTION

Methods and devices are disclosed for applying motion compensation to wavelet encoded video images and for transmitting the motion compensated wavelet encoded video images. One aspect of the invention involves an encoding device that is operable for organizing wavelet encoded images into a plurality of bit-planes, inverse wavelet transforming selected ones of the bit-planes, the inverse wavelet transformed bit-planes corresponding to an image that is representative of the video image, and estimating motion between the video image and the inverse wavelet transformed. Another aspect of the invention involves a transmitting device that is operable for identifying a type of frame and initiating a first significance based transmission process when a first type of frame is determined and initiating a second significance based transmission process when a second type of frame is determined.

### BRIEF DESCRIPTION OF THE DRAWINGS

In the figures:

FIG. 1 illustrates a transformation of wavelet encoded information into bit-planes in accordance with the principles of the invention;

FIG. 2 illustrates an exemplary encoder for generating motion compensated wavelet encoded video images according to the present invention;

FIG. 3 illustrates a flow chart of an exemplary process for motion-compensating B or P frames according to the present invention;

FIG. 4 illustrates a flow chart of an exemplary process transmitting I-frames according to the present invention;

FIGS. 5a and 5b illustrate an exemplary transmission sequence in accordance with the principles of the present invention;

FIG. 6 illustrates an exemplary system for processing wavelet encoded images in accordance with the principles of the invention;

FIG. 7 illustrates an exemplary system for operating on wavelet encoded images in accordance with the principles of the invention.

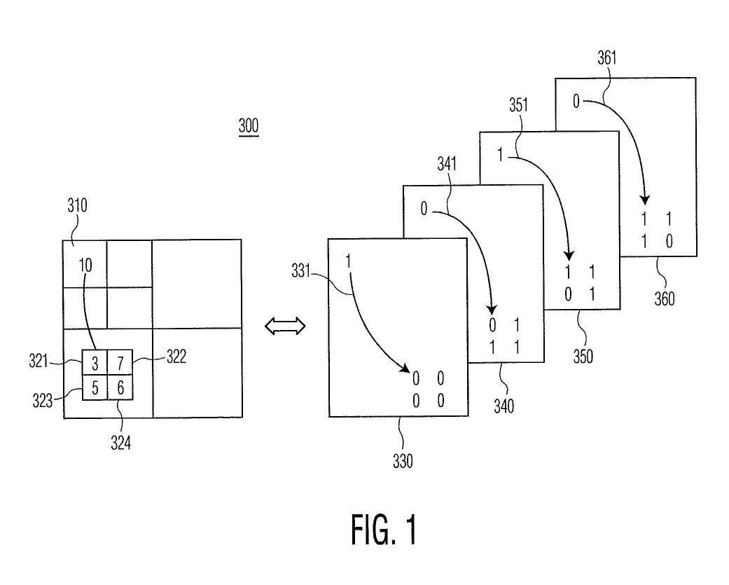

The embodiments shown in FIGS. 1 through 7 and described in the accompanying detailed description are to be used as an illustrative embodiments of the present invention and should not be construed as the only manner of practicing the invention. It is to be understood that these drawings are for purposes of illustrating the concepts of the invention and are not to scale. The same reference numerals, possibly supplemented with reference characters where appropriate, have been used to identify similar elements.

### DETAILED DESCRIPTION OF THE INVENTION

FIG. 1 illustrates an example of a wavelet-encoded image formatted into FGS enhancement layer type bit-planes 300 in accordance with the principles of the present invention. In this example, wavelet encoded, pixel element or point 310 has a value of 10, which is representative of, and provides further access to, higher resolution pixel elements, referred to as child pixels or elements, having values of 3, 7, 15 and 12, respectively. Accordingly, the value 10, represented as 1010 in a binary two numeric system, of pixel element or point 310 is encoded by distributing this value among bit-planes 330, 340, 350, and 360. Furthermore, the value of the associated high resolution pixel elements, represented as 321, 322, 323 and 324, are similarly encoded among bit-planes 330, 340, 350, and 360.

Furthermore, linkage or association with higher resolution pixel elements is also maintained, as represented by the arrows, 331, 341, 351 and 361. This association between a low-resolution and higher-resolution pixel, (parent-child relation) is advantageous as it provides for transmission of high resolution images with a finite number of bit-planes as will be shown.

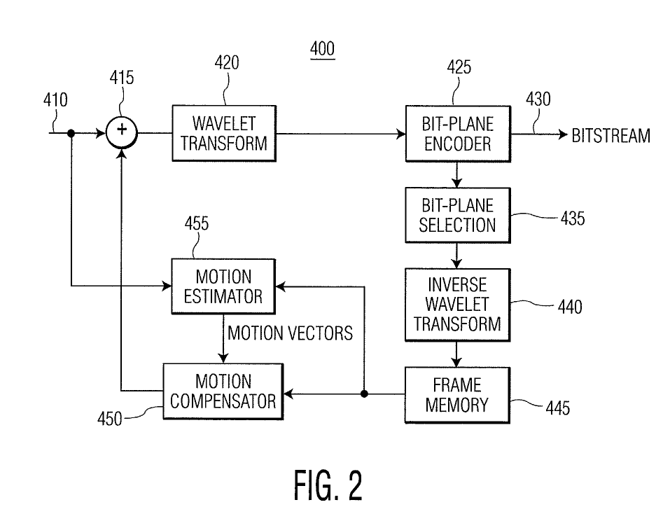

FIG. 2 illustrates a block diagram of an encoder in accordance with the principles of the present invention. In this exemplary encoder, video images, represented as 410, are concurrently applied to summing unit 415 and motion estimator 455. The output of summer 415 is then applied to wavelet transformer 420, which executes well-known processes for wavelet transformation. The wavelet-transformed output is then applied to bit-plane encoder 425 which conventionally encode the transformed image into bit-planes.

The output of bit-plane encoder 425 is then output as a bit-stream represented as 430, which may be stored on a hard disk or CD-ROM or a memory for subsequent transmission over a network, as will be explained in further detail.

The output of bit-plane encoder 425 is further applied to a bit-plane selector 435 that selects designated bit-planes for motion estimation. In a preferred embodiment, the bit-plane selector 43 selects one or more bit-planes having a highest order of information. For example, bit-plane selector 435 may select those bit-planes containing the most-significant bit of the wavelet encoded information items.

The selected bit-planes are then inverse wavelet transformed at block 440 and the result stored in a frame memory 445. The output of the frame memory 445 is then concurrently applied to motion estimator 455 and motion compensator 450. Motion estimator 455 provides motion vectors to motion compensator 450. The output of motion compensator 450 is then applied to summing unit 415. An indicator may be further stored for indicating whether the processed frame is a substantially static I-frame or a motion compensated P- or B-frame.

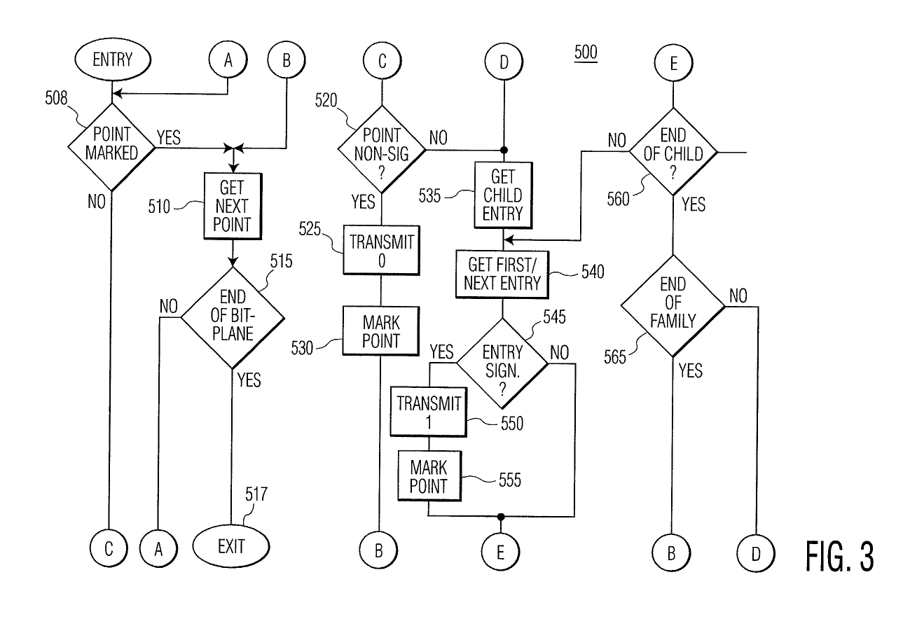

FIG. 3 illustrates a flow chart of an exemplary process 500 for transmitting motion compensating P-frame or B-frame information in accordance with the principles of the invention. In this exemplary process, a determination is made at block 505 whether a pixel or point in the bit-plane is marked. If the answer is in the affirmative, then a next point or value in the bit-plane is obtained at block 510. As will be understood, next or subsequent values in a bit-plane are conventionally obtained by scanning across each row in the bit-plane and advancing to the first pixel in a next row when an end-of-row is indicated, i.e., linear raster scan.

At block 515, a determination is made whether the end of the bit-plane is detected. If the answer is in the affirmative, the process for this bit-plane is completed at block 517. Although not shown, a next/subsequent bit-plane is accessed until the entire image is transmitted.

Returning to the determination at block 505, if the answer is negative, then a determination is made at block 520, whether the value of the point or pixel element is non-significant. If the answer is in the affirmative, then a logical zero (0) is stored for subsequent transmission. The point is marked at block 530 and processing continues at block 510 to obtain a next point.

If, however, the answer is negative, then a child element block is obtained at block 535. At block 540, a first/next pixel element in the child element block is selected. A determination is made, at block 545, whether the selected pixel element is significant. If the answer is in the affirmative, then a logical one (1) is stored for subsequent transmission at block 550 and the point is next marked at block 555.

If, however, the answer at block 545 is negative, a determination is made at block 560 whether the end of the child element block is detected. If the answer is negative, then a next/subsequent child entry is selected at block 540. The child entry is associated with the parent entry by a pointer or link. Hence, in this case reference to a next/subsequent entry, i.e., child entry, represents the use of an associated pointer and not the conventional raster scan disclosed with regard to block 510.

If, however, the answer is in the affirmative, then a determination is made at block 565, whether a family tree is detected. If the answer is negative, a next/subsequent child element block associated with each of the preceding child entries is selected at block 535 and processing continues to process each of these entries.

However, if the answer is in the affirmative, then a next pixel or point is obtained at block 510 and is processed, as described above, along with subsequent points.

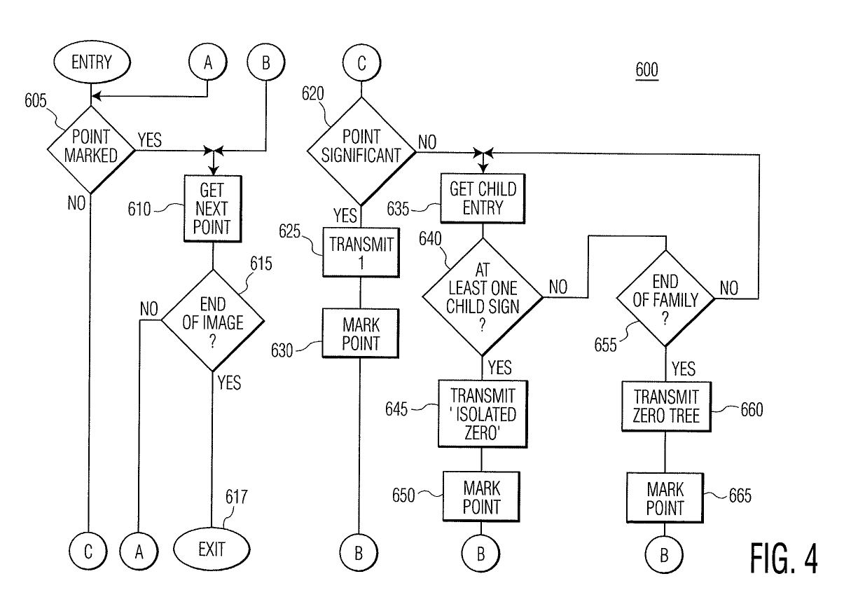

FIG. 4 illustrates a flow chart of an exemplary process 600 for transmitting I-frame information in accordance with the principles of the invention. In this process, a determination is made at block 605 whether a point is marked. If the answer is in the affirmative, then a next/subsequent point is obtained at block 610. A determination is then made, at block 615 whether an end of the bit-plane is detected. If the answer is in the affirmative, then processing ends at block 617.

Returning to the determination at block 605, if the answer is negative, then a determination is made at block 620 whether the value of the point is significant. If the answer is in the affirmative, then a logical one (1) is stored for subsequent transmission, at block 625. The point is marked at block 630 and processing continues at block 510 to obtain a next pixel or point in the bit-plane, in a conventional manner as discussed previously.

If, however, the answer to the determination at block 620 is negative, a higher resolution or child pixel block is obtained at block 635 using an associated pointer, as previously discussed. Hence, in this case, reference to a next entry constitutes use of the associated pointer. At block 640, a determination is made whether at least one pixel element in a selected child pixel block is significant. If the answer is in the affirmative, then at least one special symbol, referred-to as an “isolated zero” is stored for subsequent transmission at block 645. Each of the pixel elements is marked at block 650 and processing continues at block 610 to obtain a next point in the bit-plane.

If, however, the answer at block 640 is negative, then a determination is made at block 655 whether the end of the family line has been detected. If the answer is negative, then a next associated child element block is selected at block 635. Processing continues to process this selected child element block as previously discussed.

However, if the answer at block 655 is in the affirmative, then a special symbol, referred-to as “transmit zero tree”, is stored for subsequent transmission at block 660. The point is marked at block 665 and processing continues at block 610 to obtain a next point in the bit-plane.

In this case, rather than transmitting information items in a conventional manner, such as a linear raster scan, the present invention transmits low-resolution and associated higher-resolution data based on whether the low resolution information is considered significant, in one type of frame, or not-significant in a second type of frame.

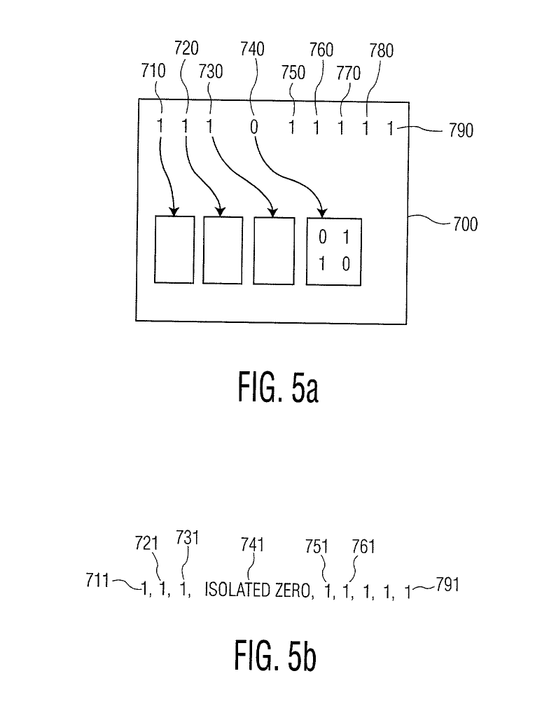

FIGS. 5a and 5b, collectively, illustrate an exemplary bit-plane 700 corresponding to encoded I-frame and the subsequent transmission sequence in accordance with processing shown in FIG. 4. In this case, bit-plane 700 includes a row of primarily significant values, e.g., logical 1 value, represented as 710, 720, 730, 750, 760, 770, 780, and 790 and a single non-significant value, 740, e.g., logical 0 value.

FIG. 5b illustrates the corresponding transmission sequence where a logical 1 value is transmitted for each significant element detected in the row, i.e., 711-731 and 751-791, and a special “isolated zero” symbol 741 when a non-significant element is detected as at least one associated child element is determined to be significant.

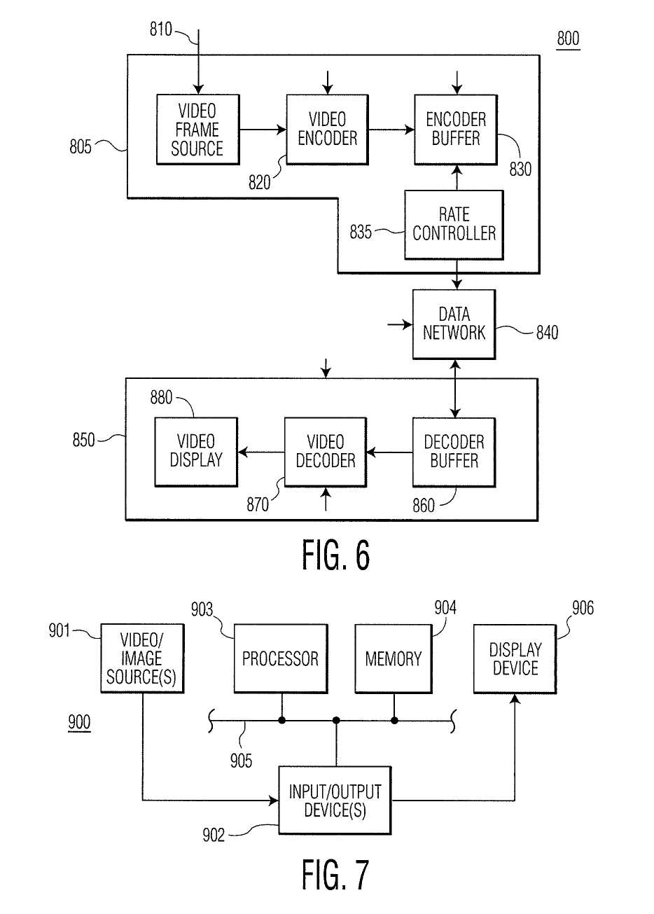

FIG. 6 illustrates a typical transmission system 800 utilizing the principles of the present invention. At transmitter site 805, video data is provided by video frame source 810 to video encoding unit 820. Video encoding unit 820 includes encoder 400 illustrated in FIG. 4. Video encoded data is then stored in encoder buffer 830 and accessed by rate controller 835 for transmission over data network 840. Rate controller 835 determines the available network 840 bandwidth, the type of frame being transmitted and selects the transmission process based on the type of frame being transmitted.

At receiving system 850, the received data frames are stored in decoder buffer 860 and provided to video decoder 870. Video decoder 870 extracts information items regarding the transmitted information necessary to decode a current transmission frame. The decoded information may then be presented on video display 880.

FIG. 7 illustrates a device 900 suitable for one of more of the transmitting and/or receiving components of the exemplary system 800. Device 900 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. System 900 receives one or more video/image sources 901, one or more input/output devices 902, a processor 903 and a memory 904. The video/image source(s) 901 may represent, e.g., a television receiver, a VCR or other video/image storage device. The source(s) 901 may alternatively represent one or more network connections for receiving video from a server or servers over, for example, a global computer communications network such as the Internet, a wide area network, a metropolitan area network, a local area network, a terrestrial broadcast system, a cable network, a satellite network, a wireless network, or a telephone network, as well as portions or combinations of these and other types of networks.

Input/output devices 902, processor 903 and memory 904 may communicate over a communication medium 905. The communication medium 905 may represent, for example, a communication bus, a communication network, one or more internal connections of a circuit, circuit card or other device, as well as portions and combinations of these and other communication media. Input video data from the source(s) 901 is processed in accordance with one or more software programs stored in memory 904 and executed by processor 803 in order to generate output video/images supplied to a display device 806.

In a preferred embodiment, the coding and decoding employing the principles of the present invention may be implemented by computer readable code executed by the system. The code may be stored in the memory 904 or read/downloaded from a memory medium such as a CD-ROM or floppy disk. In other embodiments, hardware circuitry may be used in place of, or in combination with, software instructions to implement the invention. In another aspect, the elements illustrated herein may also be implemented as discrete hardware elements that are operable to perform the operations shown in FIG. 2.

Similarly, a rate controller, may include a processor operable to execute code to perform the operations shown in FIGS. 3, 4, 5a and 5b. This processor may be selected by a method similar to or different from that used for the selection of the processor employed in the encoding unit shown in FIG. 2.

While fundamental novel features of the present invention have been shown, described, and pointed out, it will be understood that various omissions, substitutions and changes in the described apparatus, in the form and details of the devices disclosed, and in their operation, may be made by those skilled in the art without departing from the spirit of the present invention to operate on other types of wireless communication protocols. It is expressly intended that all combinations of those elements that perform substantially the same function in substantially the same way to achieve the same result are within the scope of the invention. Substitutions of elements from one described embodiment to another are also fully intended and contemplated.

What is claimed is:

1. An encoding device for motion compensating significance-based embedded wavelet encoded video, comprising:
a processor in communication with a memory, said processor operable to execute code for:
organizing wavelet encoded images into a plurality of bit-planes, wherein said bit-planes are representative of said video image;
inverse wavelet transforming selected ones of said bit-planes wherein an image corresponding to said inverse wavelet transformed bit-planes is representative of said video image;
estimating motion between said video image and said inverse wavelet transformed image.

2. The encoding device as recited in claim 1, wherein said processor is further operable to execute code for:
wavelet encoding said video image.

3. The encoding device as recited in claim 1, wherein said selected bit-planes are those bit-planes containing most-significant bits.

4. The encoding device as recited in claim 1, wherein said selected bit-planes include a known plurality of bit-planes

5. The encoding device as recited in claim 1, further comprising:
a summer unit for applying estimated motion to said video image.

6. The encoding device as recited in claim 1, wherein said processor is further operable to execute code for:
applying said estimated motion to said video image.

7. The encoding device as recited in claim 1, wherein said code is stored in said memory.

8. The encoding device as recited in claim 1, wherein said processor is further operable to indicate a type of frame.

9. The encoding device as recited in claim 8, wherein said type of frame is selected from the group comprising: I-frames, P-frames, B-frames

10. A method for motion compensating significance-based embedded wavelet encoded video images, comprising the steps of:
organizing said wavelet encoded images into a plurality of bit-planes, wherein said bit-planes are representative of said video image;
inverse wavelet transforming selected ones of said bit-planes wherein an image corresponding to said inverse wavelet transformed bit-planes are representative of said video image;
estimating motion between said video image and said image formed by said inverse wavelet transformed bit-planes.

11. The method as recited in claim 10, further comprising the step of:
wavelet encoding said video image.

12. The method as recited in 10, wherein said selected bit-planes are bit-planes having most-significant bits.

13. The method as recited in claim 10, further comprising the step of:
applying said estimated motion to said video image.

14. The method as recited in claim 10, further comprising the step of:
indicating a type of frame.

15. The method as recited in claim 14, wherein said type of frame is selected from the group comprising: I-frame, P-frames, B-frames.

16. A method for transmitting motion compensated video images which are wavelet encoded into frames, which are further bit-plane encoded, comprising the steps of:
determining a indicator associated with a selected one of said frames;
selecting an entry in a selected one of said bit-planes associated with said selected frame;
initiating a first process when said indicator is in a first state, said first process comprising the steps of:
transmitting a first value when a value of said entry is indicated to be significant;
otherwise selecting a next entry associated with said selected entry; and
transmitting a second value when at least one of said values of said selected next entry is indicated to be significant; and
initiating a second process when said indicator is in a second state, said second process comprising the steps of:
transmitting a third value when a value of said entry is indicated to be non-significant;
otherwise selecting a next entry associated with said selected entry; and
transmitting said first value for each value in said selected next entry indicated to be significant.

17. The method as recited in claim 16, further comprising the step of:
marking each of said entries transmitted.

18. The method as recited in claim 16, wherein said first process comprises the step of:
transmitting a fourth value when said all of said next entries are processed.

19. The method as recited in claim 18, wherein said transmitted values are selected from the group comprising: logical 1, logical 0, “isolated zero”, “zero tree.”

20. A transmitting device suitable for transmitting motion compensated video images which are wavelet encoded into frames, which are further bit-plane encoded, comprising:
a processor in communication with a memory operable to execute code for:
determining a indicator associated with a selected one of said frames;
selecting an entry in a selected bit-plane associated with said selected frame;
initiating a first process when said indicator is in a first state, said first process comprising the steps of:
transmitting a first value when a value of said entry is indicated to be significant;
otherwise selecting a next entry associated with said selected entry; and
transmitting a second value when at least one of said values of said selected next entry is indicated to be significant; and
initiating a second process when said indicator is in a second state, said second process comprising the steps of:
transmitting a third value when a value of said entry is indicated to be non-significant;
otherwise selecting a next entry associated with said selected entry; and
transmitting said first value for each value in said selected next entry indicated to be significant.

21. The transmitting device as recited in claim 20, wherein said processor is further operable to execute code for:
marking each of said entries transmitted.

22. The transmitting device as recited in claim 20, wherein said first process further comprises the step of:
transmitting a fourth value when said all of said next entries are processed.

23. The transmitting device as recited in claim 22, wherein said transmitted values are selected from the group comprising: logical 1, logical 0, “isolated zero”, “zero tree.”

24. The transmitting device as recited in claim 20, wherein said code in contained in said memory.

25. The transmitting device as recited in claim 20, wherein said processor is in communication with an I/O device for receiving said bit-plane, wavelet encoded video images.

26. An encoding device for motion compensating significance-based embedded wavelet encoded video, comprising:
means for organizing wavelet encoded images into a plurality of bit-planes, wherein said bit-planes are representative of said video image;
means for inverse wavelet transforming selected ones of said bit-planes wherein an image corresponding to said inverse wavelet transformed bit-planes is representative of said video image;
means for estimating motion between said video image and said inverse wavelet transformed image.

27. A transmitting device suitable for transmitting motion compensated video images which are wavelet encoded into frames, which are further bit-plane encoded, comprising:
means for determining a indicator associated with a selected one of said frames;
means for selecting an entry in a selected bit-plane associated with said selected frame;
means for initiating a first process when said indicator is in a first state, said first process comprising the steps of:
transmitting a first value when a value of said entry is indicated to be significant;
otherwise, selecting a next entry associated with said selected entry; and
means for transmitting a second value when at least one of said values of said selected next entry is indicated to be significant; and
means for initiating a second process when said indicator is in a second state, said second process comprising the steps of:
transmitting a third value when a value of said entry is indicated to be non-significant;
otherwise selecting a next entry associated with said selected entry; and
transmitting said first value for each value in said selected next entry indicated to be significant.
